(19) United States
(12) Patent Application Publication
(10) Pub. No.: US 2009/0090316 A1
(43) Pub. Date: Apr. 9, 2009

(54) ENGINE BODY STRUCTURE

(75) Inventor: Shinichi Yamazawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HINO MOTORS, LTD, TOKYO (JP)

(21) Appl. No.: 12/160,167

(22) PCT Filed: Jan. 9, 2007
(86) PCT No.: PCT/JP2007/000005

§ 371 Date: Jul. 9, 2008

(30) Foreign Application Priority Data
Jan. 10, 2006 (JP) 2006-002255

(51) Int. Cl. F02B 75/22

(52) U.S. Cl. 123/54.4

(57) ABSTRACT

A timing gear case 13 is fastened to a front end of a cylinder block 1 for a V-type engine, cylinder heads 14 being fastened to and striding over upper ends of the cylinder block 1 and of the timing gear case 13, a head cover 15 being fastened to an upper end of the cylinder head 14, so that the cylinder head 14 may be detached from the cylinder block 1 even if the timing gear case 13 is kept fastened to the cylinder block 1.

Cam gears 21 and 22 fitted over camshafts assembled in the cylinder head 14 and a cam idle gear 20 are pivoted to the cylinder head 14, so that parts of a valve operating system may be assembled in the cylinder head 14 before it is fastened to the cylinder block 1.

Thus, an engine body structure is provided which has enhanced workability in maintenance and enhanced reliability in service.

### TECHNICAL FIELD

The present invention relates to an engine body structure.

### BACKGROUND ART

Not only an inline engine with cylinders arranged in a line but also a V-type engine with cylinders arranged oppositely in right and left banks are included in internal combustion engines for vehicles.

In comparison with the inline engine, the V-type engine is disadvantageous in cost because of complexly shaped cylinder blocks and because of two cylinder heads required, but is advantageous in mountability because of shortness in whole length and possible lowness in whole height.

FIGS. 1 and 2 show a conventional engine body structure which comprises a cylinder block 1, right and left cylinder heads 2 fastened to an upper end of the cylinder block 1, a timing gear case 3 covering and fastened to front ends of the cylinder block 1 and of the cylinder heads 2, right and left head covers 4 each striding over and fastened to upper ends of the corresponding cylinder head 2 and of the timing gear case 3, a flywheel housing 5 fastened to a rear end of the cylinder block 1 and an oil pan 6 fastened to a lower end of the cylinder block 1, thus providing a V-type engine.

When looking this V-type engine from ahead, the front end of the cylinder block 1 and the front end of the cylinder head 2 are behind of and concealed by the timing gear case 3.

In general, belt- or chain-drive using an endless body is extensively employed for a timing gear which transmits rotation of a crankshaft 7 to camshafts (not shown) in a valve operating system.

In the belt-driven type timing gear, an endless timing belt (not shown) is wound about a crank pulley 8 and cam pulleys 9 and 10, the pulleys 8 and 9 and 10 being fitted over front ends of the crankshaft 7 and camshafts (not shown), respectively, these components being arranged within the timing gear case 3.

In an engine with higher normal revolution speed, in lieu of belt or chain which may readily vibrate due to the revolution, a gear train may be used as means for transmitting the revolution of the crankshaft 7 to the camshafts (see, for example, non-patent Reference 1).

[Non-patent Reference 1] “How mechanisms of automobiles work? Engine Systems” edited by GP Planning Center, pp. 66-71, published on Feb. 28, 2003 by Kabushiki Kaisha Grand Prix Shuppan, 15th edition

### SUMMARY OF THE INVENTION

### Problems to be Solved by the Invention

With an intent of enhancing an engine normal revolution speed of a commercial motor vehicle for which overhaul may be conducted repeatedly during in service, application of a gear-train-driven timing gear to a V-type engine shown in FIGS. 1 and 2 was reviewed to find out that such engine body structure is disadvantageous in workability in maintenance since the cylinder head 2 cannot be detached without detaching the timing gear case 3 from the cylinder block 1 beforehand.

Moreover, there is a fear of oil leaking in service since a surface 11 of the timing gear case 3 vertically facing to the cylinder head 2 has an upper end abutting on a sealed lower edge surface 12 of the head cover 4.

The invention was made in view of the above and has its object to provide an engine body structure which has excellent workability in maintenance and enhanced reliability in service.

### Means or Measures for Solving the Problems

In order to attain the above object, provided in the invention are a cylinder block for a V-type engine, a timing gear case fastened to a front end of the cylinder block so as to cover the gear train, cylinder heads each fastened to and striding over both upper ends of the cylinder block and of the timing gear case and a head cover fastened to an upper end of each of the cylinder heads.

Specifically, the assembling is such that the cylinder head rests on the upper ends of the cylinder block and timing gear case, so that the cylinder head can be detached from the cylinder block even if the timing gear case is kept fastened to the cylinder block, a sealed lower edge surface of the head cover facing only to the cylinder head.

A surface of the cylinder head facing to the cylinder block and timing gear case is made planar for facilitation in machining the cylinder head.

Cam gears which are fitted over camshafts assembled in the cylinder head and a cam idle gear in mesh with both of gear trains on the front end side of the cylinder block are pivoted to the cylinder head, so that parts of a valve operating system may be assembled in the cylinder head before it rests on the cylinder block.

### EFFECTS OF THE INVENTION

An engine body structure according to the invention can exhibit the following excellent effects and advantages.

(1) Since the assembling is such that each of the cylinder head rests on the upper ends of the cylinder block and timing gear case, the cylinder head can be detached from the cylinder block even if the timing gear case is kept fastened to the cylinder block, resulting in excellent workability in maintenance.
(2) Since the sealed lower edge surface of the head cover faces only to the cylinder head, there is no fear of oil leaking, resulting in enhanced reliability in service.
(3) By making planar the surface of the cylinder head facing to the cylinder block and timing gear case, machining of cylinder head is facilitated, leading to reduction in fabrication cost.
(4) By pivoting to the cylinder head the cam gears which are fitted over the camshafts assembled in the cylinder head and the cam idle gear in mesh with both the gear trains on the front end side of the cylinder block, parts of the valve operating system may be assembled in the cylinder head before it rests on the cylinder block, leading to rationalization in work steps.

### BRIEF DESCRIPTION OF THE DRAWINGS

FIG. 1 is a side view showing an example of V-type engine with a conventional engine body structure;

FIG. 2 is a view looking in the direction of arrows II in FIG. 1;

FIG. 3 is a side view showing an example of V-type engine with an engine body structure according to the invention;

FIG. 4 is a view looking in the direction of arrows II in FIG. 3;

FIG. 5 is a side view showing an example of an inline engine to which the cylinder head shown in FIG. 3 is applied; and

FIG. 6 is a view looking in the direction arrows VI in FIG. 5.

### EXPLANATION OF THE REFERENCE NUMERALS

1 cylinder block
13 timing gear case
14 cylinder head
15 head cover
20 cam idle gear
21 cam gear
22 cam gear
23 sideway facing surface

### BEST MODE FOR CARRYING OUT THE INVENTION

Embodiments of the invention will be described in conjunction with the drawings.

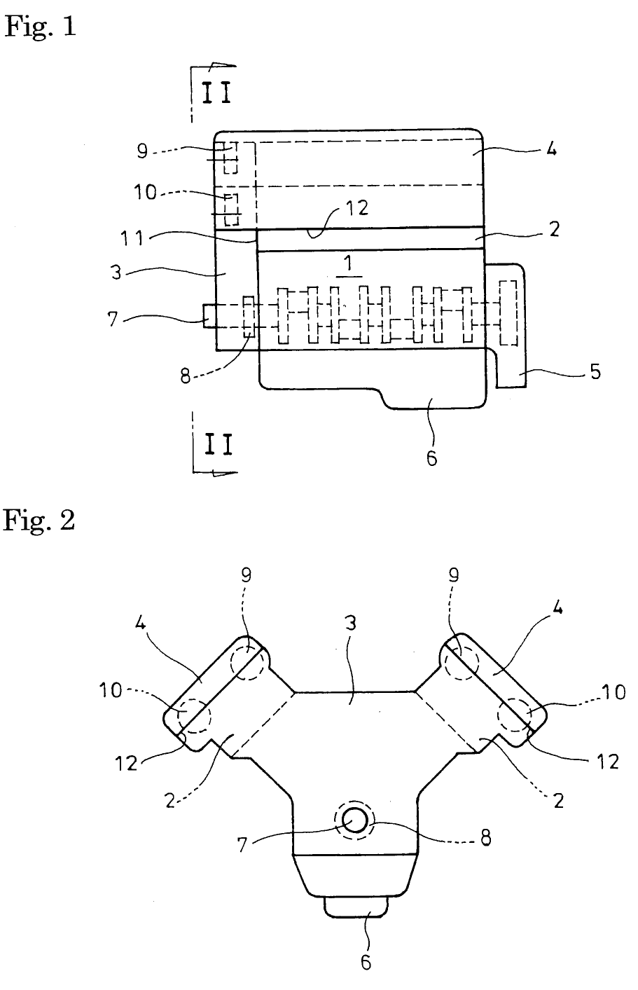

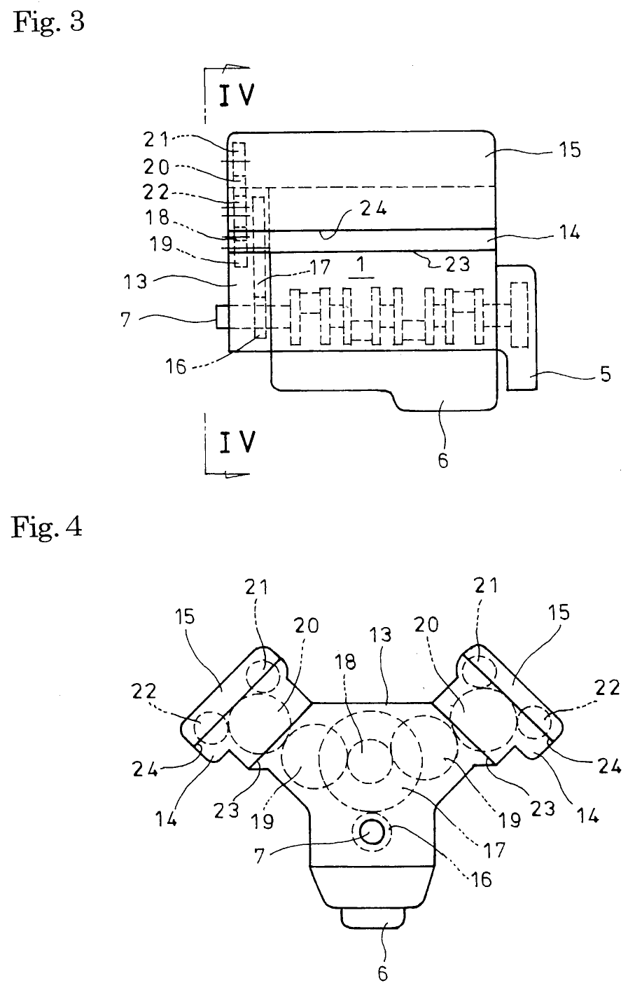

FIGS. 3 and 4 show an embodiment of the engine body structure according to the invention in which parts similar to those in FIGS. 1 and 2 are represented by the same reference numerals.

A V-type engine comprises a cylinder block 1, a timing gear case 13 fastened to a front end of the cylinder block 1, right and left cylinder heads 14 each striding over and fastened to upper ends of the cylinder block 1 and of the timing gear case 13, right and left head covers 15 each fastened to an upper end of the corresponding cylinder head 14, a flywheel housing 5 fastened to a rear end of the cylinder block 1 and an oil pan 6 fastened to a lower end of the cylinder block 1.

When looking this V-type engine from ahead, the cylinder heads 14 laterally oppositely rest on the timing gear case 3 and the head covers 15 rest on the corresponding cylinder heads 14, the front end of the cylinder block 1 being behind of and concealed by the timing gear case 13.

More specifically, the assembling is such that each of the cylinder head 14 rests on the upper ends of the cylinder block 1 and of the timing gear case 13, so that the right and left cylinder heads 14 may be detached from the cylinder block 1 even if the timing gear case 13 is kept fastened to the cylinder block 1, resulting in excellent workability in maintenance.

With the timing gear case 13 being fastened to the cylinder block 1, the surface of the cylinder block 1 on which the cylinder head 14 rests is made coplanar with the surface of the timing gear case 13 on which the cylinder head 14 rests; accordingly, a sideway facing surface 23 of the cylinder head 14 facing to the cylinder block 1 and timing gear case 13 is made planar.

Thus, the sideway facing surface 23 of the cylinder head 14 can be easily and accurately shaped by surface grinding, using a milling cutter.

Moreover, since the cylinder head 14 rests on the cylinder block 1 and timing gear case 13 and the sealed lower edge surface of the head cover 15 faces only to the cylinder head 14, the is no fear of oil leaking, resulting in enhanced reliability in service.

Employed as drive for the timing gear which transmits the revolution of the crankshaft 7 to the camshafts (not shown) is a gear train comprising a crank gear 16 fitted over a front end of the crankshaft 7, a larger diameter main idle gear 17 in mesh with the gear 16, a smaller diameter main idle gear 18 rotated integrally with the gear 17, right and left sub idle gears 19 in mesh with the gear 18, right and left cam idle gears 20 in mesh with the gears 19, respectively, and right and left cam gears 21 and 22 each fitted to a corresponding camshaft (not shown) and in mesh with the corresponding gear 20.

The gears 16, 17, 18 and 19 are accommodated in the timing gear case 13, the gears 20, 21 and 22 being pivoted to the corresponding cylinder head 14.

Thus, before the cylinder head 14 rests on the cylinder block 1, various parts of a valve operating system such as camshafts can be mounted to the cylinder head 14, whereby work steps can be rationalized.

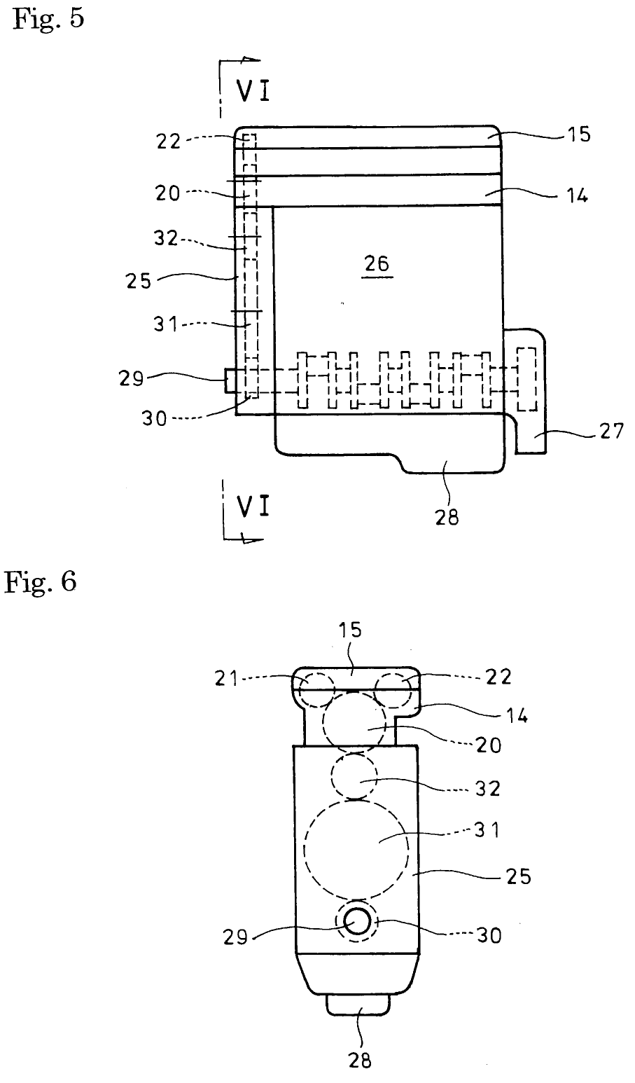

When attention is focused on the fact that parts of the valve operating system may be preliminarily assembled and that the sideway facing surface 23 is planar, it may be considered that the cylinder head 14 is applied to an inline engine as shown in FIGS. 5 and 6.

The inline engine comprises a cylinder block 26 to a front end of which a timing gear case 25 is fastened, a cylinder head 14 being fastened to stride over both the upper ends of the cylinder block 26 and of the timing gear case 25, a head cover 15 being fastened to an upper end of the cylinder head 14.

Fastened to a rear end of the cylinder block 25 is a flywheel housing 27; fastened to a lower end of the cylinder block 25 is an oil pan 28.

Employed as timing gear is a gear train comprising a crank gear 30 fitted to a front end of the crankshaft 29, a main idle gear 31 in mesh with the gear 30, a sub idle gear 32 in mesh with the gear 31, a cam idle gear 20 in mesh with the gear 32 and cam gears 21 and 22 fitted over front ends of camshafts (not shown) and in mesh with the gear 20.

The crank gear 30, main idle gear 31 and sub idle gear 32 are arranged within the timing gear case 25; the cam idle gear 20 and the cam gears 21 and 22 are pivoted to the cylinder head 14.

When such cylinder head 14, head cover 15, cam idle gear 20 and cam gears 21 and 22 are commonly used for V-type and inline engines, the number of parts are reduced to facilitate production management.

It is to be understood that an engine body structure according to the invention is not limited to the above-mentioned embodiment and that various changes and modifications may be made without leaving the gist of the invention.

### INDUSTRIAL APPLICABILITY

An engine body structure according to the invention may be applicable to engines with various purposes.

1. An engine body structure comprising a cylinder block for a V-type engine, a timing gear case fastened to a front end of the cylinder block so as to cover a gear train, cylinder heads each fastened to and striding over both upper ends of the cylinder block and of the timing gear case and a head cover fastened to an upper end of each of the cylinder heads.

2. An engine body structure as claimed in claim 1, wherein a surface of the cylinder head facing to the cylinder block and timing gear case is made planar.

3. An engine body structure as claimed in claim 1, wherein cam gears which are fitted over camshafts assembled in the cylinder head and a cam idle gear in mesh with both of gear trains on the front end side of the cylinder block are pivoted to the cylinder head.
